(19) United States
(12) Patent Application Publication
(10) Pub. No.: US 2019/0056702 A1
(43) Pub. Date: Feb. 21, 2019

(54) MODEL-BASED MACHINE LEARING CONTROL SYSTEM AND METHOD FOR TUNING POWER PRODUCTION EMISSIONS

(71) Applicant: General Electric Company, Schenectady, NY (US)

(72) Inventors: Mathew Doyle Angel, Greenville, SC (US); Brian Whitright, Simpsonville, SC (US)

(21) Appl. No.: 15/682,334

(22) Filed: Aug. 21, 2017

(51) Int. Cl. G05B 13/04; G05B 13/02

(52) U.S. Cl. CPC G05B 13/042; G05B 13/0265

(57) ABSTRACT

A model-based control system comprises a processor. The processor is configured to select a desired parameter of a machinery configured to produce power and to output emissions, and to select an emissions model configured to use the desired parameter as input and to output an emissions parameter. The processor is further configured to continuously tune the emissions model during operations of the machinery via a tuning system to derive a setpoint, and to adjust the setpoint by applying a tuning bias, wherein the tuning bias is continuously updated via segmented linear regression. The processor is additionally configured to control one or more actuators coupled to the machinery based on the adjusted setpoint.

### BACKGROUND OF THE INVENTION

The subject matter disclosed herein relates to power generation systems. In particular, the embodiments described herein relate to control systems applying machine learning for tuning emissions of power generation systems.

Many control systems for power generation systems may use a variety of models to predict the performance of the power generation system and control various aspects of the system based on the prediction. These models may be physics-based models that predict performance based on the relationships between the components of the power generation system, physics of the component materials, and the operating environment. Often, these models may be determined based on known physical relationships between parameters (e.g., a known relationship between pressure and volume) as well as relationships captured through both lab and on-site testing.

After the physics-based models are created, the models may be tuned to account for actual variations in field conditions and data during requisitioning, which typically occurs during commissioning of the power generation system. However, tuning models based on actual variations in field conditions and data is often a manual process which may be time- and labor-consuming. For instance, the actual variations may vary from site to site, increasing the amount of time and effort required to determine the variations in field conditions and data and tune the models in the control system at each site. Additionally the variations may themselves change over time due to the operation and/or degradation of components in the power generation system and the control system. Accordingly, it would be beneficial to improve model based control and modeling for emissions tuning.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a model-based control system comprises a processor. The processor is configured to select a desired parameter of a machinery configured to produce power and to output emissions, and to select an emissions model configured to use the desired parameter as input and to output an emissions parameter. The processor is further configured to continuously tune the emissions model during operations of the machinery via a tuning system to derive a setpoint, and to adjust the setpoint by applying a tuning bias, wherein the tuning bias is continuously updated via segmented linear regression. The processor is additionally configured to control one or more actuators coupled to the machinery based on the adjusted setpoint.

In a second embodiment, a method includes selecting a desired parameter of a machinery configured to produce power and to output emissions, and selecting an emissions model configured to use the desired parameter as input and to output an emissions parameter. The method further includes continuously tuning the emissions model during operations of the machinery via a tuning system to derive a setpoint via machine learning, and adjusting the setpoint by applying a tuning bias, wherein the tuning bias is continuously updated via segmented linear regression. The method additionally includes controlling one or more actuators coupled to the machinery based on the adjusted setpoint.

In a third embodiment, a non-transitory, computer-readable medium includes executable code including instructions. The instructions are configured to select a desired parameter of a machinery configured to produce power and to output emissions, and to select an emissions model configured to use the desired parameter as input and to output an emissions parameter. The instructions are further configured to continuously tune the emissions model during operations of the machinery via tuning system to derive a setpoint via machine learning, and to adjust the setpoint by applying a tuning bias, wherein the tuning bias is continuously updated via segmented linear regression. The instructions are additionally configured to control one or more actuators coupled to the machinery based on the setpoint.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of a model-based control system that may be used to control power production machinery, in accordance with an embodiment of the present approach;

FIG. 2 illustrates a block diagram of the components of the power production machinery and the model-based control system of FIG. 1, in accordance with an embodiment of the present approach;

FIG. 3 illustrates a flow chart for a process that the model-based control system of FIG. 1 may use to control the power production machinery and improve the models of the control system, in accordance with an embodiment of the present approach;

FIG. 4 illustrates an embodiment of a process to use model-based empirical tuning of emissions for the power production machinery of FIG. 1;

FIG. 5 is a chart illustrating an embodiment of a transfer function bias tuning at first point in time;

FIG. 6 is a chart illustrating an embodiment of a transfer function bias tuning at a second point in time;

FIG. 7 is a chart illustrating an embodiment of a transfer function bias tuning at a third point in time; and

FIG. 8 illustrates an example temperature versus megawatt operating diagram that may be applied to operate the power production machinery after the tuning process of FIG. 8.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments generally relate to continuous emissions tuning and model-based control of power production machinery, such as gas turbines, steam turbines, wind turbines, and/or hydro turbines. In particular, the embodiments described herein relate to using models to monitor and continuously tune emissions while additionally or alternatively controlling the operation of the power production machinery and simultaneously improving the models to account for actual field conditions and data. For example, in one embodiment, the models may be used to sense operations and/or emissions (e.g., particulates, nitrous oxides [NOx]) of a turbomachinery and to continuously tune emissions and/or operations of the turbomachinery based on the sensed data.

In certain embodiments, techniques such as segmented linear regression may be used to dynamically tune, for example, a bias used to improve or otherwise “correct” a transfer function. The transfer function may model emissions, such as NOx emissions based on a combustion reference temperature (CRT). The tuning techniques described herein may be “turn key.” That is, no previous training of data may be required, the tuning may “learn” from an in situ installation simply by observing operational data. Further, the techniques described herein may be more computational efficient and compact, as opposed to techniques such as neural networks and the like. In certain embodiments, an emissions monitoring system, an emissions model, a segmented linear regression model, and a rough tuning algorithm may be used to continuously tune a power production system. The emissions model and emissions monitoring system in turn may be used to tune the segmented linear regression model, for example, to current gas turbine emissions. Once the segmented linear regression model is tuned, the rough tuning algorithm may compare gas turbine measurement(s) to emissions monitoring system measurement(s) and to the output of the quadratic regression model and apply a tuning bias to reduce any error between the emission monitoring measurement and the quadratic regression model. As new operating conditions are achieved based on either ambient conditions and/or turbine degradation, the model(s) may be continuously updated with the latest data.

Additionally, the techniques described herein provide for using surrogacy, where a surrogate measurement having a first measurement type or parameter having a first measurement type is used as a stand-in for a different measurement having a second measurement type or parameter having a second measurement type, the first measurement type different form the second measurement type. Some example surrogate measurements include various power measurements, measured inlet pressure loss, compressor discharge pressure, and bearing temperature which may stand-in for any of the following fuel gas inner cavity pressure, fuel gas temperature, exhaust pressure, inlet filter differential pressure, head loss, measured exhaust pressure loss, and tank temperature, or a combination thereof. Accordingly, a sensor may be used as a surrogate sensor “standing in” for one or more other sensors, including sensors of different types. For example, the first measurement and the second measurement types may include temperature, pressure, clearance measurements (e.g., distances between stationary and rotating component), speed (e.g., RPM), flow rates, electrical values (e.g., amperage, voltage, resistance, and capacitance), fuel type, and fluid level. Accordingly, depending on the model, any of the first type of measurements may be transformed into the second type of measurements based on the surrogacy techniques described herein. For example, flow rate may be converted to speed, clearance may be converted to temperature, fluid level may be converted to pressure, and so on. Accordingly, a first sensor type (e.g., temperature, pressure, clearance measurements (e.g., distances between stationary and rotating component), speed (e.g., RPM), flow rates, electrical values (e.g., amperage, voltage, resistance, capacitance), fuel type, fluid level, or combination thereof,) may be used as a stand-in or surrogate for a second, different sensor type (e.g., temperature, pressure, clearance measurements (e.g., distances between stationary and rotating component), speed (e.g., RPM), flow rates, electrical values (e.g., amperage, voltage, resistance, capacitance), fuel type, fluid level, or combination thereof).

As mentioned earlier embodiments described may also include a “quadratic regression” model tuned to a continuous emissions monitoring system (CEMS) to improve the accuracy of an empirically derived emissions model for gas turbine combustion control. The CEMS may include 5 components or systems: 1) the emissions monitoring system, 2) emissions model(s), 3) the quadratic regression model, 4) the rough tuning algorithm or process, and 5) the segmented linear regression model. The emissions model(s) and emissions monitoring system are used to tune the quadratic regression model to current gas turbine emissions. The quadratic regression model may be tuned continuously, for example via the segmented linear regression model, the rough tuning algorithm compares the gas turbine measurement from the emissions monitoring system measurement and the output of the quadratic regression model and applies a tuning bias to reduce any error between the emission monitoring measurement and the quadratic regression model.

Further, the CEMS may use surrogate measurements instead of or additional to certain measurements. By using multiple surrogates, in type and in kind, to determine other measurement(s) or parameter(s), the CEMS may forgo relying on a single measurement or parameter. That is, rather than relying, on a measurement such as pressure, the techniques described herein may additionally or alternatively use a surrogate (e.g., temperature), for example, to determine emissions levels. This, in turn, may increase the reliability, accuracy, and predictive capability of the models, which may provide for improved model based control. Further, as will be described in further detail below, the CEMS may tune the models in real-time, in some embodiments without previous knowledge (e.g., field data collection) of the relationships between surrogates and desired measurements or parameters, thereby increasing the accuracy of the models. Additionally, by tuning the models without relying on previous knowledge of the relationships between surrogate parameters and desired parameters, the CEMS may quickly re-tune any models after components of the power production machinery are updated and/or replaced. The CEMS may also suspend or disregard tuning of the models. For instance, the CEMS may suspend tuning of the models when the surrogate measurements or parameters, the derived measurements or parameters, and/or the tuned models indicate that the power production machinery is operating in relatively constant operating conditions and environment.

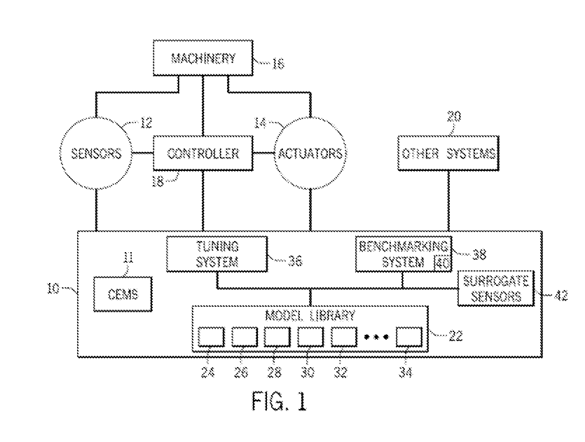

With the foregoing in mind, FIG. 1 is a block diagram illustrating an embodiment of a model-based control system (MBCS) 10 that may be communicatively coupled to sensors 12 and actuators 14, which in turn may be coupled to machinery 16. The MBCS 10 may include (e.g., as a subsystem) or be coupled to a continuous emissions monitoring system (CEMS) 11. The sensors 12 may provide inputs to the MTCS 10, and may include, for example, pressure sensors, temperature sensors, flow sensors, status and position indicators (e.g. limit switches, Hall effect switches, acoustic proximity switches, linear variable differential transformers (LVDTs), position transducers), and the like, connected to and the machinery 16. The actuators 14 may include switches, valves, motors, solenoids, positioners, and other devices, suitable for moving or controlling a mechanism or system within the machinery 16. The machinery 16 may be any type of turbomachinery, power production machinery (e.g., gas turbine system, steam turbine system, wind turbine system, hydroturbine system, combustion engine, hydraulic engine, electric generator), and non-power production machinery (e.g., pump, valve).

In certain embodiments, the MTCS 10 may be provided as a subsystem of a controller 18 that is coupled to the machinery 16 and may control the actuators 14. In such embodiments, the MTCS 10 may include non-transitory machine readable media storing code or computer instructions that may be used by a computing device (e.g., the controller 18) to implement the techniques disclosed herein. In other embodiments, the MTCS 10 may constitute the entirety of the controller 18; that is, the MTCS 10 may be responsible for all of the control responsibilities for the machinery 16. In still other embodiments, the MTCS 10 may be included in a distributed control system (DCS), a manufacturing execution system (MES), a supervisor control and data acquisition (SCADA) system, and/or a human machine interface (HMI) system. Likewise, the CEMS 11 may be provided as a subsystem of the MTCS 10, or as a separate system included in a separate DCS, MES, and/or SCADA system and communicatively coupled to the MTCS 10.

The MTCS 10 may also be coupled to other systems 20, such as electronic logs (e.g., maintenance databases), paper logs, power production logs, manufacturer records (e.g., expected lifetime data, repair data, refurbishment data), industry records (e.g., industry failure rate data, industry standards), economic markets (e.g., power futures market, cap and trade markets, “green” credit markets), regulatory systems (e.g., regulatory compliance systems, pollution control systems), insurance systems (e.g., lost power production revenue insurance, business interruption insurance), maintenance optimization systems, operational optimization systems, economic optimization systems, and so on. The MTCS 10 may use the data provided by the other systems 20 to tune the models used to determine the performance of the machinery 16, which is described in further detail below.

As shown in FIG. 1, the MTCS 10 may include a model library 22 containing models 24, 26, 28, 30, 32, and 34. The models 24-34 may include various types of relationships between certain measurements or parameters of the machinery 16 during operations of the machinery 16. In certain embodiments, the models 24-34 may be physics-based models determined based on known physical relationships between parameters (e.g., a known relationship between pressure and volume) as well as relationships captured through both lab and on-site testing. For example, the models 24, 26, 28, 30, 32, and 34 may include one or more emissions model that may take as input a first set of parameters of a gas turbine system (e.g., speed, temperatures, fluid flows, pressures, fuel type) and used by the CEMS 11 to output a second set of parameters related to emissions (e.g., particulate count, concentration of certain chemicals such as nitrogen oxides [NOx], hydrocarbons (HC), carbon monoxide (CO), and other emissions), as described in more detail below. The models 24, 26, 28, 30, 32, and 34 may include one or more quadratic regression models, as described in more detail below. The models 24, 26, 28, 30, 32, and 34 may additionally include one or more segmented linear regression models that apply certain regression techniques described in more detail below, suitable for creating and/or tuning various of the models 24, 26, 28, 30, 32, and 34.

The MTCS 10 may also include a tuning system 36, which may tune the models 24-34, including emissions model 34, as described further below, for example via the segmented linear regression model(s). Additionally, the MTCS 10 may include surrogate sensors 38. Although the surrogate sensors 38 may essentially be physical sensors 12, the MTCS 10 may use the data collected by the surrogate sensors 38 as inputs to derive virtual sensors “measuring” values that may have different types as those measured by the surrogate sensor 38. For example, the surrogate sensor 38 may physically measure pressure, while the derived virtual sensor based on data collected via the surrogate sensor 38 may “measure” temperature, as will be described in further detail below.

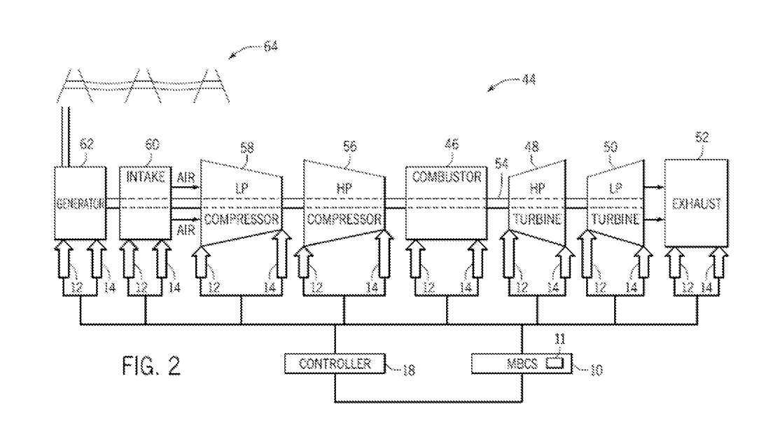

Turning now to FIG. 2, an example of using the MTCS 10 and the CEMS 11 to apply surrogacy and model tuning to machinery 16 in the form of a turbine system 40 is provided. As depicted, the turbine system 40 may include a combustor 42, which may receive fuel that has been mixed with air for combustion in a chamber within combustor 42. This combustion creates hot pressurized exhaust gases. The combustor 42 directs the exhaust gases through a high pressure (HP) turbine 44 and a low pressure (LP) turbine 46 toward an exhaust outlet 48. The HP turbine 44 may be part of a HP rotor. Similarly, the LP turbine 46 may be part of a LP rotor. As the exhaust gases pass through the HP turbine 44 and the LP turbine 46, the gases force turbine blades to rotate a drive shaft 50 along an axis of the turbine system 40. As illustrated, drive shaft 50 is connected to various components of the turbine system 40, including a HP compressor 52 and a LP compressor 54.

The drive shaft 50 may include one or more shafts that may be, for example, concentrically aligned. The drive shaft 50 may include a shaft connecting the HP turbine 44 to the HP compressor 52 to form a HP rotor. The HP compressor 52 may include blades coupled to the drive shaft 50. Thus, rotation of turbine blades in the HP turbine 44 causes the shaft connecting the HP turbine 44 to the HP compressor 52 to rotate blades within the HP compressor 52. This compresses air in the HP compressor 52. Similarly, the drive shaft 50 includes a shaft connecting the LP turbine 46 to the LP compressor 54 to form a LP rotor. The LP compressor 54 includes blades coupled to the drive shaft 50. Thus, rotation of turbine blades in the LP turbine 46 causes the shaft connecting the LP turbine 46 to the LP compressor 54 to rotate blades within the LP compressor 54. The rotation of blades in the HP compressor 52 and the LP compressor 54 compresses air that is received via an air intake 56. The compressed air is fed to the combustor 42 and mixed with fuel to allow for higher efficiency combustion. Thus, the turbine system 40 may include a dual concentric shafting arrangement, wherein LP turbine 46 is drivingly connected to LP compressor 54 by a first shaft portion of the drive shaft 50, while the HP turbine 44 is similarly drivingly connected to the HP compressor 52 by a second shaft portion of the drive shaft 50 internal and concentric to the first shaft. Shaft 50 may also be connected to an electrical generator 58. The generator 58 may be connected to an electrical distribution grid 60 suitable for distributing the electricity produced by the generator 58.

As shown in FIG. 2, multiple sensors 12 and actuators 14 may be disposed in or around various components of the turbine system 40. The sensors 12 may be configured to collect data regarding various parameters related to the operation and performance of the turbine system 40, such as parameters related to the components of the turbine system 40 as well as certain materials (e.g., air, fuel, etc.) inputted into or outputted by the turbine system 40. For example, the sensors 12 may measure environmental conditions, such as ambient temperature and ambient pressure, as well as a plurality of engine parameters related to the operation and performance of the turbine system 40, such as, exhaust gas temperature, rotor speed, engine temperature, engine pressure, gas temperature, engine fuel flow, vibration, clearance between rotating and stationary components, compressor discharge pressure, exhaust emissions/pollutants, and turbine exhaust pressure. In certain embodiments, the sensors 12 may also measure data related to the actuators 14, such as valve position, and a geometry position of variable geometry components (e.g., air inlet).

Typically, in model-based control systems, the data collected by the sensors 12 is inputted into the models, which generates data quantifying the operation and performance of the machinery 16. Based on the generated data, the control system then determines a number of control actions to take in order to improve and/or maintain the performance of the machinery 16 and controls the actuators 14 as necessary to perform the control actions. For example, to determine the compressor pressure ratio of the HP compressor 52 or the LP compressor 54, one or more pressure sensors 12 may be disposed in the drive shaft 50 before and after the HP compressor 52 and the LP compressor 54. That is, in certain derivations, the models may rely only on inputs directly related to the desired derivations of the models. In other derivations, the models may use inputs indirectly related to the desired derivations. For example, fuel gas inner cavity pressure, fuel gas temperature, exhaust pressure, inlet-filter-differential-pressure can be used as surrogates for a variety of other sensors (e.g. head-loss), mass flow, and so on.

Typically, the models used by the model-based control systems may be tuned, in that certain parameters and/or constants in the physical and/empirical relationships between parameters may be adjusted in order to improve the accuracy of the models. However, while the models may be tuned to account for variations in field conditions, such tuning typically occurs only during commissioning of the machinery 16. That is, the models may be tuned, usually manually, when the machinery 16 and the controller 18 are installed. The models may not be re-tuned to account for variations in field conditions that occur due to the operation and/or degradation of the sensors 12, the actuators 14, and components of the machinery 16. Further, once the models are tuned during the initial installation of the machinery 16 and the controller 18, the models may not be re-tuned if any components of the machinery 16 and the controller 18 are updated or replaced. Additionally, the models may not be individually tuned to account for different modes of operations for the machinery 16.

To improve the accuracy of the models 24-34 and the performance of the machinery 16, the MTCS 10 may use the tuning system 36 and/or the surrogate sensors 38 to automatically tune the models 24-34 and determine one more parameters of the machinery 16, respectively, as noted above. Further, the turning system 36 may include segmented linear regression tuning, and may be done continuously. The MTCS 10 may additionally determine one or more surrogate measurements or parameters that may be mathematically related to a desired measurement or parameter of the machinery 16. The MTCS 10 may then select one of the models 24-34 that include the relationship (e.g., mathematical relationship) between the surrogate(s) and the desired measurement(s) or parameter(s), and may use the selected model to derive the desired measurement(s) or parameter(s). Further, the tuning system 36 may tune the selected model based on the surrogate measurement(s) or parameter(s), and/or the relationship between the surrogate measurement(s) or parameter(s) and the desired measurement(s) or parameter(s). In use, the controller 18 may derive one or more virtual sensors based on physical surrogate sensor 38 readings. The virtual sensors may then be used to check their corresponding physical sensor, as a replacement to the physical sensor, and/or may also be used to add a second channel of data additional to the first channel of data provided by the physical sensor corresponding to the virtual sensor. By applying the surrogacy techniques described herein, increased robustness and capability for the system 10 may be provided.

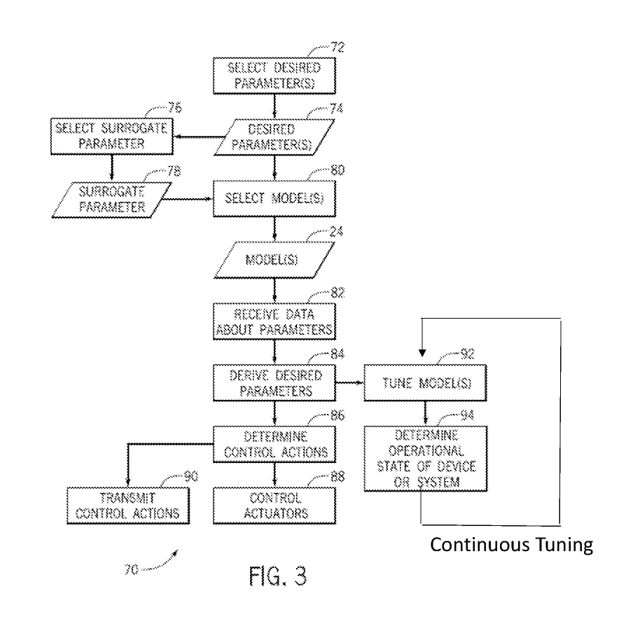

FIG. 3 illustrates an embodiment of a process 70 that the MTCS 10 and the tuning system 36 may use to determine a desired measurement or parameter of the machinery 16 and tune the models 24-34, for example based on surrogate sensors 38. Although the process 70 is described below in detail, the process 70 may include other steps not shown in FIG. 3. Additionally, the steps illustrated may be performed concurrently or in a different order. The process 70 may be implemented as computer instructions or executable code stored in the memory and executed by the processor of the MTCS 10 and the controller 18.

Beginning at block 72, the MTCS 10 may select a desired measurement or parameter 74 of the machinery 16 to derive. For instance, the MTCS 10 may select the air pressure of the drive shaft 50 as a desired parameter 74. At block 76, the MTCS 10 may then select one or more surrogate measurements or parameters 78 that may be related (e.g., mathematically related) to the desired parameter 74. The surrogate parameter(s) 78 may be determined based on, for example, certain relationships between two variables. Following the earlier example, the MTCS 10 may select air temperature in the drive shaft 50 as a surrogate parameter 78 based on the relationship between pressure and temperature in the form of Boyle's law. In other embodiments, the surrogate measurements or parameter(s) 78 may be determined based on empirically determined relationships between two types of measurements or parameters (e.g., relationships determined via lab and/or field testing). In certain embodiments, the MTCS 10 may also determine boundary measurements or parameters for the surrogate parameter(s) 78. That is, while there may be no observable or a weak correlation between a particular measurement or parameter and the desired measurements or parameter 74, the parameter may still be used to set boundary conditions for the surrogate measurements or parameter(s) 78. These boundary measurements or parameters may be used to determine when the data collected by the surrogate sensor(s) 38 associated with the surrogate measurements or parameter(s) 78 is unsuitable and may be disregarded by the tuning system 36, which is described further below.

After the MTCS 10 determines the surrogate parameter(s) 78, the MTCS 10 may then select one or more models 24-34 from the model library 22 at block 80. As will be appreciated, the models 24-34 may include one or more relationships between the surrogate measurements or parameter(s) 78 and the desired measurements or parameter 74. Once the MTCS 10 determines the desired measurement or parameter 74, the surrogate measurement(s) or parameter(s) 78, and the model(s) 24-34, the MTCS 10 may receive data representative of the surrogate measurement(s) or parameter(s) 78 via the surrogate sensors 38 at block 82. As noted above, the surrogate sensors 38 are sensors 12 disposed within and around the machinery 16. However, they are designated as surrogate sensors 38 to reflect that the data collected by the surrogate sensors 38 is used specifically to determine the desired measurements or parameter 74. At block 84, the MTCS 10 then uses the data from the surrogate sensors 38 and the model(s) 24-34 to determine the desired measurements or parameter 74. By using surrogate(s) 78, and, in certain embodiments, boundary measurements or parameters, the MTCS 10 may increase the number of data streams or points, which may increase the accuracy of the calculation of the desired measurement or parameter 74 when compared to other model-based control systems that rely on a single operating point or multiple similar operating points (e.g., determining compressor pressure ratio based on a single pressure measurement).

Once the MTCS 10 derives the desired measurements or parameter 74, the MTCS 10 may then determine one more control actions to take at least partially based on the derived desired measurements or parameter at block 86. For example, the MTCS 10 may derive an air-to-fuel ratio as the parameter 74, and then adjust a position of a corresponding fuel valve based on the derived air-to-fuel ratio (e.g., close the valve if the air-to-fuel ratio is low). The MTCS 10 may then either control the actuators 14 directly to perform the control actions or transmit the control actions to a separate controller, such as the controller 18, at blocks 88 and 90, respectively.

In addition to controlling the actuators 14, the MTCS 10 also uses the tuning system 36 to tune the model(s) 24-34 at block 92, as shown in FIG. 3. In one embodiment, the tuning system 36 may perform real-time meta regression analysis of the model(s) 24-34, for example, via segmented linear regression. While other empirical methods for tuning models (e.g., matrix algebra, fuzzy logic, neuro-fuzzy models, etc.), may be used, in a preferred embodiment, using segmented regression analysis allows the tuning system 36 to exploit the relationships between surrogate parameters and desired parameters as well as tune the models 24-34 in real-time. Further, the turning may be provide “turnkey” without any a priori information. That is, tuning may start as soon as data is received, and the tuning may be continuous.

The tuned models may then be used to determine (block 94) operational state(s) of device or systems, such as model predicted combustion reference temperature(s) (CRT), temperatures for other components, pressures, speed (e.g., RPM), turbine 44 power levels, flow rates, generation levels (e.g., megawatts), and so on. The operational state may additionally include emissions such as NOx levels, carbon oxides (COx) levels, particulate counts, sulfur oxides (Sox) levels, N₂ levels, O₂ levels, H₂O levels, hydrocarbon (e.g., CxHx) and so on.

In particular, the tuning system 36 may use the segmented linear regression method that includes continuously modeling data as data becomes available during operations, for example to tune a bias, as further described below. By using segmented linear regression, the tuning system 36 may perform regression analysis not only in real-time but also automatically as data is being collected (as opposed to waiting for enough data to be collected) regarding the surrogate parameter(s) 78 and the desired parameter 74. For instance, in certain embodiments, the models based on the segmented regression analysis may be stored in the memory of the MTCS 10 or the tuning system 36, allowing the tuning system 36 to use the previous models to continuously tune new models.

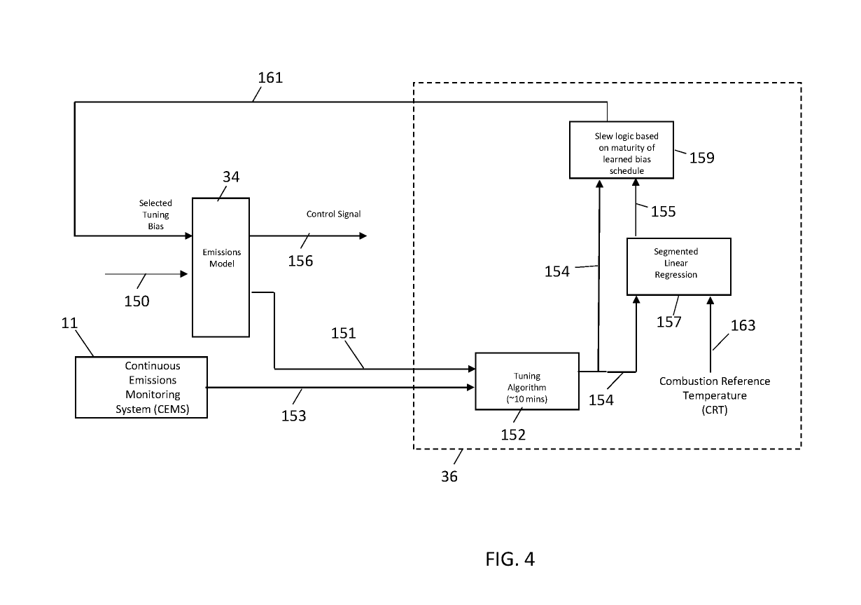

FIG. 4 is a block diagram of an example configuration of the CEMS 11 and the tuning system 36. As shown, the tuning system 36 may use the emissions model 34 as input, and more specifically, as an f(x) input. In the depicted embodiment, the emissions model 34 in turn may model emissions as a function of turbine system 44 operating conditions, fuel composition, and/or environmental conditions. For example, one or more parameters 150 may be used as input into the emissions model 34. In an exemplary embodiment, a combustion reference temperature (CRT) may be used as the input 150 into the model 34, representative of a combustion temperature for the combustor 46. The model 34 may then derive, based on the input 150, certain emissions parameters such as NOx levels, carbon oxides (COx) levels, particulate counts, sulfur oxides (Sox) levels, N₂ levels, O₂ levels, H₂O levels, hydrocarbon (e.g., CxHx) and so on. The model may include physics based models, neural network based models, computer fluid dynamic models, regression analysis models, and so on.

While, in one embodiment, input 150 refers to CRT, in other embodiments, input 150 may include additional or alternative parameters, such as any number of parameters related to the turbine system 44, including compressor discharge pressure, inlet guide vane position, load, fuel type, fluid flows related to components of the turbine system 44, pressures related to components of the turbine system 44, temperatures related to components of the turbine system 44, speed related to components of the turbine system 44, clearances (e.g., distance between moving and stationary components of the turbine system 44), generator 62 parameters such as power production and the like. It is also to be noted that the input 150 may include surrogate parameters. For example, speed of turbines 48 and/or 50 may be used as a surrogate for CRT. Likewise, fluid flows, pressures, speeds, clearances, and/or loads of any of the components 46, 48, 50, 52, 54, 56, 58, 60, 62 of the turbine system 44 may be used as surrogate(s) for the CRT and part of the input 150.

The tuning system 36 may receive the outputs from the emissions model 34 and from the CEMS 11. More specifically, the CEMS 11 may be continuously monitoring the turbine system 44 and provide observed or “real world” values Y (e.g., empirical values) as opposed to derived or predicted values f(x) 151, such as a NOx transfer function. That is, while the emissions model 34 may predict certain values f(x), the observed values Y may be used to tune, improve and/or update the emissions model 34. Accordingly, predicted values f(x) may be used as inputs 151 and observed values Y may be used as inputs 153 into the turning system 36. Indeed, by applying the tuning system 36 as described earlier, a segmented regression analysis may be used to tune the emissions model in real time.

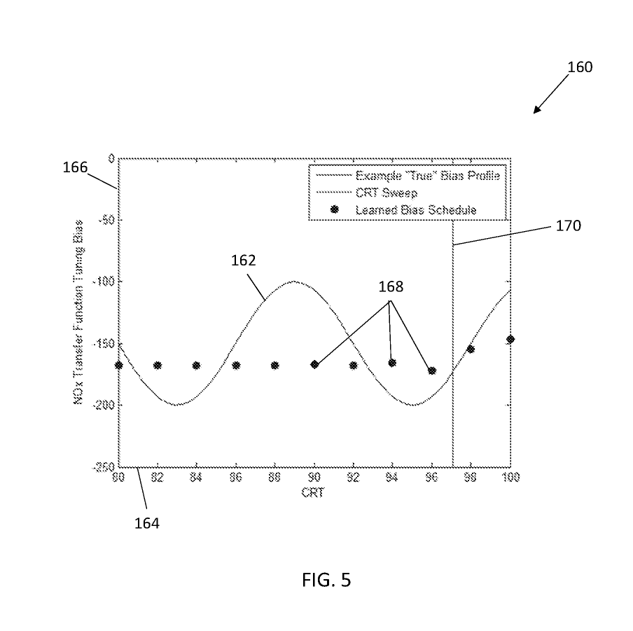

In the depicted embodiment, a tuning algorithm 152 may use as input the parameters observed via the CEMS 11 and the parameter(s) 151 to further adjust or tune the parameter 151. For example, the tuning algorithm 152 may compare a turbine systems 44 measurement from the CEMS 11 and the output 151 of the emission model 34 and derive a tuning bias 154 to reduce any error between the CEMS 11 measurement and the model output 151. To improve the tuning bias 154, the turning system 36 may apply segmented linear regression model(s) 157 and slew logic 159. The segmented linear regression model(s) 157 may use the bias produced via the tuning algorithm 152 (e.g., tuning bias 154) as input to derive a more accurate transfer function tuning bias as output via segmented linear regression techniques, for example by creating a schedule of turning bias values of a function of CRT (e.g., piecewise linear function CRT), as described in more detail below with respect to FIGS. 5-7. While in one embodiment, the segmented linear regression uses CRT as input 163, in other embodiments a surrogate for CRT may be used as input 163, as well as other temperatures, pressures, flows, and so on.

Implementing segmented linear regression may be less computationally intensive than implementing other techniques (e.g., machine learning). In segmented linear regression, the data may be split into two or more sections, each split denoted by a “breakpoint.” As new data is received because of continuing operations, the breakpoint may be “moved” to analyze the new data but incorporating older data. For example, the breakpoint may be a point in time between the older data (segment A) and the newer data (segment B). Thus, the breakpoint may move as new data is acquired. Accordingly, the segmented linear regression model(s) 157 may create a schedule of tuning bias values. The tuning the bias, for example, may be based on various properties of the observed system, as described earlier, but in one specific example, a function of CRT may be tuned for bias.

The slew logic 159 may use the tuning bias 154 at a current operation condition (e.g., output from tuning algorithm 152) and an interpolated output 155 of learned tuning bias schedule (e.g., output of the segmented linear regression model(s) 157) to “skew” or otherwise shift, for example, time shift, the turning bias 154 based on a “maturity” of the learned bias schedule, e.g., based on how well the learned bias schedule appears to match the actual operating conditions. Thus skewed, a tuning bias 161 may then be used to as input to the emission model 34 and used to provide an improved control signal 156 to control the turbine system 44, such as a temperature control signal, fuel flow signal, signal to actuate an actuator such as a pump, switch, relay, and so on. The tuning bias 161 may also continuously tuned as new operational data comes in as well as when the emissions model 34 provides for new derivations. By dynamically tuning the model 34 and by using empirical data in the tuning process, emissions may be more accurately controlled.

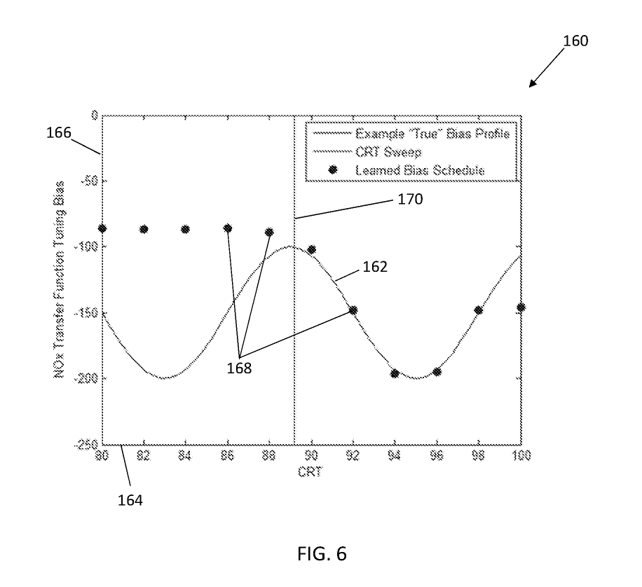

FIGS. 5, 6, and 7 illustrate an example graph 160 depicting an embodiment of a “true” bias function 162. The true bias function 162 is depicted plotted against an X axis 164 and a Y axis 166. The true bias function 162 is illustrative of the correct bias function to apply to eliminate error. The Y axis 166 is based on CRT values, while the Y axis 166 is based on tuning bias values. For example, a bias of zero means that there should be no bias applied. Also depicted are bias points 168 showing currently derived bias. As operations for the observed system progress and new data is captured, a CRT sweep 170 moves to a new CRT value observed and segmented linear regression is then re-executed to “learn” a new bias and the points 168 are repositioned to the learned bias. For example, in FIG. 6, the CRT sweep 170 is at a CRT of between 96 and 98.

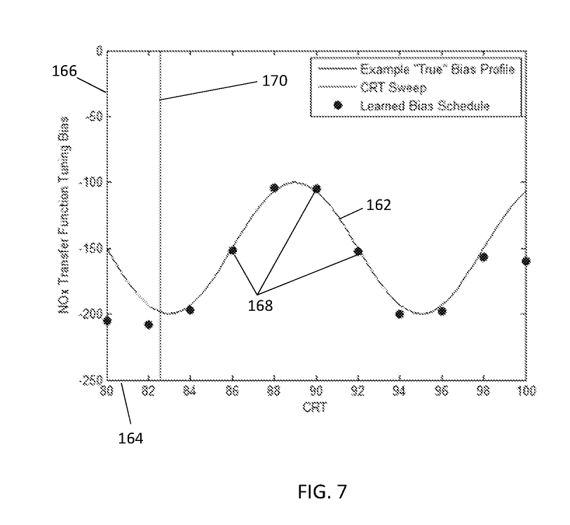

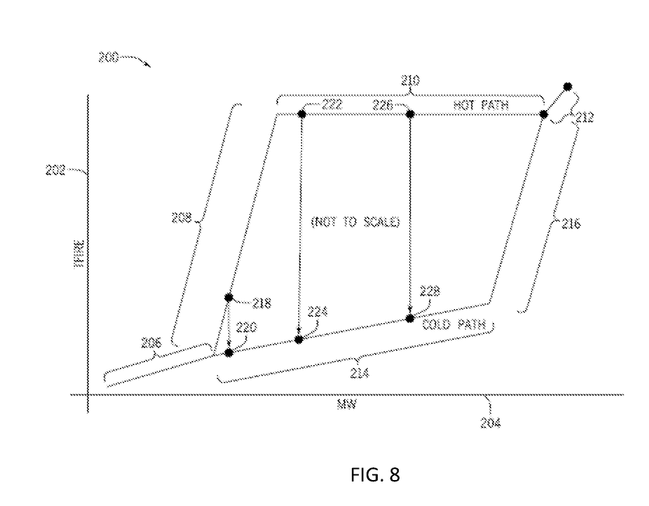

As data is received, FIG. 7 shows how applying segmented linear regression results in more updated bias points 168. Thus, the number of points 168 which now better fit the true bias function 162, has increased in FIG. 7 when compared to FIG. 6. In FIG. 7, the CRT sweep 170 is between CRT values of 88 and 90. As further data is received, FIG. 8 shows that further applying segmented linear regression as CRT sweep 170 sweeps more data results in more updated bias points 168. Thus, the number of points 168 which now better fit the true bias function 162, has increased as depicted in FIG. 8 when compared to FIGS. 6 and 7.

FIG. 9 depicts a chart 200 having a Y-axis 202 representative of a firing temperature for the turbine system 44 and an X-axis 204 representative of megawatts produced. In operations, such as during startup, a hot path is usually followed. For example, to follow the hot path, the controller 18 may follow paths 206, 208, 210, and 212. However, hot path operations may result in increased wear and tear on equipment. Accordingly, a cold path may be followed, which respects emissions limits by applying the CEMS 11 and tuning the emissions model 34 as described earlier in FIG. 5. The input 150 may include a desired Tfire temperature on the axis 202, and the tuning system 36 may then provide for the control signal 156 suitable to arrive at the desired Tfire temperature. In this manner, megawatts produced at points 218, 222, and 226, for example, may now be produced at points 220, 224, 228, respectively, following the cold path through segments 206, 214, and 216. By following the cold path and maintaining emissions compliance, the tuned emissions model 34 may provide for enhanced component life for the components of the turbine system 44 and improved operations.

Technical effects of the invention include monitoring and controlling power production machinery using a model-based control system. In particular, certain embodiments may improve the accuracy of the models used by the model-based control system. For example, the model-based control system may dynamically, empirically, and continuously tune an emissions model (e.g., bias tuning) via segmented linear regression. The tuned emission model may then be used to provide for a quadratic regression setpoints useful in deriving a control signal to arrive at desired emissions. Further, the model-based control system may enable cold path operations of power production machinery as opposed to hot path operations, thus improving component life.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A model-based control system, comprising:
a processor configured to:
select a desired parameter of a machinery configured to produce power and to output emissions;
select an emissions model configured to use the desired parameter as input and to output an emissions parameter;
continuously tune the emissions model during operations of the machinery via a tuning system to derive a setpoint;
adjust the setpoint by applying a tuning bias, wherein the tuning bias is continuously updated via segmented linear regression, and
control one or more actuators coupled to the machinery based on the adjusted setpoint.

2. The system of claim 1, wherein applying the tuning bias comprises deriving a transfer function tuning bias via the segmented linear regression.

3. The system of claim 2, wherein the transfer function comprises a Nitrogen oxides (NOx) transfer function.

4. The system of claim 3, wherein the NOx transfer function comprises a polynomial based on a compressor reference temperature (CRT).

5. The system of claim 1, wherein the processor is configured to adjust the setpoint by comparing an observed machinery measurement and a value derived via the setpoint and applying the tuning bias to reduce any error between the machinery measurement and the value.

6. The system of claim 1, wherein the value comprises a gas turbine emissions value.

7. The system of claim 1, wherein the processor is configured to select a surrogate parameter, wherein the emissions model is configured to use the surrogate parameter as a stand-in for the desired parameter, wherein the desired parameter comprises a first measurement type, and wherein the surrogate parameter comprises a second measurement type different than the first measurement type.

8. The system of claim 7, wherein the surrogate parameter comprises a compressor discharge pressure, a turbine speed, a fluid flow, an inlet guide vane position, or a combination thereof.

9. The system of claim 1, wherein the processor is configured to operate the machinery by following a cold path based on the setpoint, and wherein the machinery comprises a gas turbine system.

10. A method, comprising:
selecting a desired parameter of a machinery configured to produce power and to output emissions;
selecting an emissions model configured to use the desired parameter as input and to output an emissions parameter;
continuously tuning the emissions model during operations of the machinery via a tuning system to derive a setpoint via machine learning;
adjusting the setpoint by applying a tuning bias, wherein the tuning bias is continuously updated via segmented linear regression; and
controlling one or more actuators coupled to the machinery based on the adjusted setpoint.

11. The method of claim 10, wherein applying a tuning bias comprises deriving a transfer function tuning bias via the segmented linear regression.

12. The method of claim 11, wherein the transfer function comprises a Nitrogen oxides (NOx) transfer function.

13. The method of claim 12, wherein the NOx transfer function comprises a polynomial based on a compressor reference temperature (CRT).

14. The method of claim 10, wherein adjusting the setpoint comprises comparing an observed machinery measurement and a value derived via the setpoint and applying the tuning bias to reduce any error between the machinery measurement and the value.

15. The method of claim 10, selecting a surrogate parameter, wherein the emissions model is configured to use the surrogate parameter as a stand-in for the desired parameter, wherein the desired parameter comprises a first measurement type, and wherein the surrogate parameter comprises a second measurement type different than the first measurement type.

16. The method of claim 15, comprising operating the machinery by following a cold path based on the setpoint, and wherein the machinery comprises a gas turbine system.

17. A non-transitory, computer-readable medium comprising executable code comprising instructions configured to:
select a desired parameter of a machinery configured to produce power and to output emissions;
select an emissions model configured to use the desired parameter as input and to output an emissions parameter;
continuously tune the emissions model during operations of the machinery via tuning system to derive a setpoint via machine learning;
adjust the setpoint by applying a tuning bias, wherein the tuning bias is continuously updated via segmented linear regression; and
control one or more actuators coupled to the machinery based on the setpoint.

18. The non-transitory, computer-readable medium of claim 17, wherein applying a tuning bias comprises deriving a transfer function tuning bias via the segmented linear regression.

19. The non-transitory, computer-readable medium of claim 18, wherein the transfer function comprises a Nitrogen oxides (NOx) transfer function.

20. The non-transitory, computer-readable medium of claim 17, wherein the instructions are configured to select a surrogate parameter, wherein the emissions model is configured to use the surrogate parameter as a stand-in for the desired parameter, wherein the desired parameter comprises a first measurement type, and wherein the surrogate parameter comprises a second measurement type different than the first measurement type.
